(19) United States
(12) Patent Application Publication
(10) Pub. No.: US 2026/0093604 A1
(43) Pub. Date: Apr. 2, 2026

(54) DEVICE DATA ACCESS VIA A MANAGEMENT CONTROLLER

(71) Applicant: Intel Corporation, Santa Clara, CA (US)

(72) Inventors: Patrick G. KUTCH, Tigard, OR (US); Brian P. JOHNSON, Forest Grove, OR (US)

(21) Appl. No.: 19/412,086

(22) Filed: Dec. 8, 2025

(51) Int. Cl. G06F 11/362; G06F 11/3698

(52) U.S. Cl. CPC G06F 11/366; G06F 11/3698

(57) ABSTRACT

Examples described herein relate to a first interface to a device; a second interface to the device; and a circuitry to: based on inoperability of the first interface or inoperability of the device, utilize the second interface to communicate with the device and to retrieve debug data from the device and provide the debug data to a requester, wherein the first and second interfaces utilize different protocols. In some examples, the debug data comprises three or more of: timestamped events, error messages, informational messages generated by the device's firmware or software, connectivity errors, hardware errors, or system events.

Debugging and fine-tuning hardware components integrated into a host system is a complex and a time-consuming process. During early development phases of a device (e.g., graphics processing units (GPUs), storage controllers, accelerators, network interface devices, or others), integrating the device into an existing host system can lead to pre-release devices and drivers crashing unexpectedly, making root-cause analysis difficult. Register contents provide configuration information, error states, and operational metrics that indicate an internal state of the device at the time of failure. However, in some circumstances, such as when a device crashes, registers may become inaccessible via the system's primary interface, such as a bus, so that debugging cannot be performed.

### BRIEF DESCRIPTION OF THE DRAWINGS

FIG. 1 depicts an example system.

FIG. 2 depicts an example of operations.

FIG. 3 shows an example process.

FIG. 4 depicts a system.

### DETAILED DESCRIPTION

Despite failure of a device to operate (e.g., power-on, connect to a device interface, or others), a manageability interface to the device can remain operative. Various examples provide a management controller that can request and retrieve contents of a device, that is failing to connect to a host system or has inoperative circuitry, using the manageability interface. Based on receipt of an instruction from a requester (e.g., using a Distributed Management Task Force (DMTF) protocol) at the management controller, after authentication, the management controller can issue a targeted request to a device, specifying one or more registers to read-from or write-to. The device can respond by providing access to contents of the requested register or writing to the registers. Contents of the register can include timestamped events, error messages, warnings, informational messages generated by the device's firmware or software, connectivity errors, hardware errors, system events, or others. The management controller could transmit the contents to a requester (e.g., a remote engineer or automated diagnostic tool for analysis). The requester can determine a cause of device failure and correct issues that lead to the device failure. This capability can permit low-level debugging and root-cause analysis even when the host system cannot enumerate or communicate with the device.

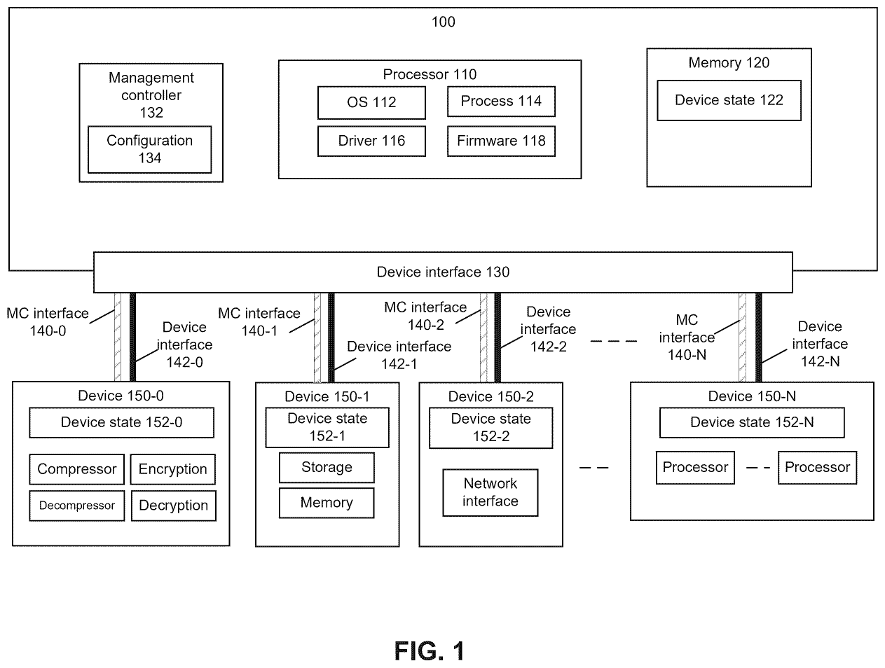

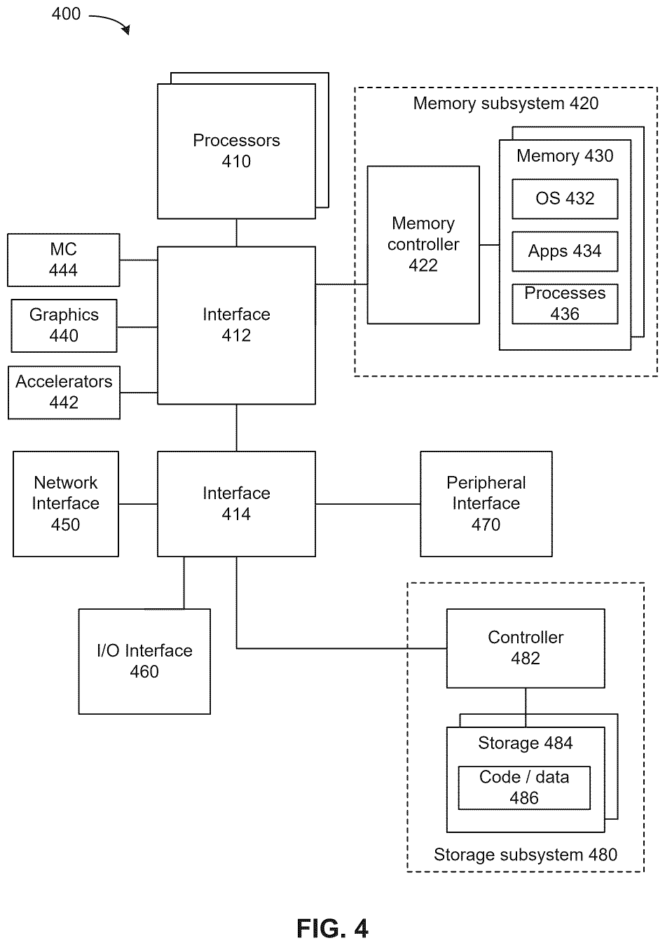

FIG. 1 depicts an example system. Host system 100 can include one or more processors 110, memory 120, management controller 132, and other circuitry and software described at least with respect to FIG. 4. Processors 110 can execute at least one or more of: operating system (OS) 112, processes 114, driver 116, firmware 118, and other software. Processes 114 can include one or more of: an application, process, thread, a virtual machine (VM), microVM, container, microservice, virtual function (VF), virtual device, or other virtualized execution environment. Driver 116 can provide a communication interface between processor 110 and one or more devices 150-0 to 150-N, where N is an integer. Processor 110 can access one or more of devices 150-0 to 150-N using device interfaces 142-0 to 140-N consistent at least with Peripheral Component Interconnect express (PCIe), Compute Express Link (CXL), or other standards. The PCIe protocol is described in Peripheral Component Interconnect (PCI) Express Base Specification 1.0 (2002), as well as earlier versions, later versions, and variations thereof. The CXL protocol is described in Compute Express Link Specification version 1.0 (2019), as well as earlier versions, later versions, and variations thereof). Processor 110 can access one or more of devices 150-0 to 150-N as Single Root I/O Virtualization (SR-IOV) virtual functions (VFs) or Scalable I/O Virtualization (SIOV) Assignable Device Interfaces (ADIs).

Memory 120 can include one or more registers, volatile memory, non-volatile memory, cache, or other circuitry. Memory 120 can store device state 122 accessed from host system 100 or from one or more of devices 150-0 to 150-N. Memory 120 can store other data and processes accessed by processors 110.

Devices 150-0 to 150-N can include one or more of: an accelerator, graphics processing unit (GPU), storage device, memory device, network interface device, or other circuitry. For example, an accelerator can perform cryptographic, compression, or decompression operations on data stored in memory 120.

Management controller (MC) 132 can include a processor configured to perform monitoring of device temperature, fan speeds, and power status. Management controller 132 can be configured to respond to remote actions by performance of actions such as power cycling, booting, and resetting devices or circuitry. Management controller 132 can provide management capabilities independent of OS 112, through a dedicated management network port and can support protocols such as Intelligent Platform Management Interface (IPMI) and Redfish. Management controller 132 can provide telemetry and crash data for troubleshooting and proactive maintenance. Management controller 132 can be used to automate the initial setup and firmware updates for servers. In some examples, management controller 132 can be implemented as one or more of: Baseboard Management Controller (BMC), Intel® Management or Manageability Engine (ME), or other devices.

Configuration 134 can specify permitted requesters, permitted accesses to registers by requesters (e.g., read, write, or read and write). For example, configuration 134 can identify particular internet protocol (IP) address of a requester, permitted registers that can be accessed for particular devices, permitted actions by a requester (e.g., read, write, or read and write). For example, a requesters can supply a username and password to management controller 132 over a Transport Layer Security (TLS) protocol link and configuration 134 can specify a permission level of the requester. For example, some requesters can have privileges that permit reading, some have permission that permits write, others have permission to read and write.

As described herein, interfaces 140-0 to 140-N between devices 150-0 to 150-N and management controller 132 can permit management controller 132 to access devices 150-0 to 150-N despite failure or inoperability of devices 150-0 to 150-N or failures of devices 150-0 to 150-N to communicate with host 100 using device interfaces 142-0 to 142-N. Interfaces 140-0 to 140-N can operate in accordance at least with System Management Bus (SMBus), Inter-Integrated Circuit (I2C), Peripheral Component Interconnect express (PCIe), Universal Serial Bus (USB), Reduced Media Independent Interface-Based Transport (RBT), Improved Inter-Integrated Circuit (I3C), or others.

Interfaces 140-0 to 140-N and device interfaces 142-0 to 142-N can utilize different protocols to communicate with devices 150-0 to 150-N. For example, management controller 132 can utilize DMTF protocols over interfaces 140-0 to 140-N to access memory, registers, or other circuitry of devices 150-0 to 150-N. DMTF protocols can include at least Network Controller Sideband Interface (NC-SI), Management Component Transport Protocol (MCTP), Platform Level Data Model (PLDM), or others.

Management controller 132 can be configured to access device registers in response to a request and, based on permission to carry out the request in configuration 134, provide contents of the registers despite the device being inoperative or unable to connect with host 100. To enhance security and control, this capability could be disabled by default and require explicit enablement, such as by firmware 118, in configuration 134.

Management controller 132 can access circuitry, memory, and devices of a host system for monitoring and management. For example, management controller 132 can access device state data 152-0 to 152-N from memory or registers of devices 150-0 to 150-N even when the device are no longer enumerated on the device interface 130 (e.g., PCIe bus). In some examples, device state data 152-0 to 152-N can be written to devices by driver or firmware and can include log files including timestamped events, error messages, device warnings, informational messages generated by the device's firmware or software, connectivity errors, hardware errors, system events, crash reports, stack traces, operating system version, processor utilization, memory consumption, power supply stability, actual data being processed when the failure occurred, data from hardware debug interfaces (e.g., Joint Test Action Group (JTAG) or Universal Serial Bus (USB) debug probes) that indicate the state of registers, information on configuration bit settings, network configurations (e.g., Access Point Name (APN) settings), or others.

Management controller 132 can store device state data into memory 120 as device state 120 and cause transmission of the device state to a requester via a network interface device using a protocol (e.g., DMTF) or debug interface (e.g., JTAG or others).

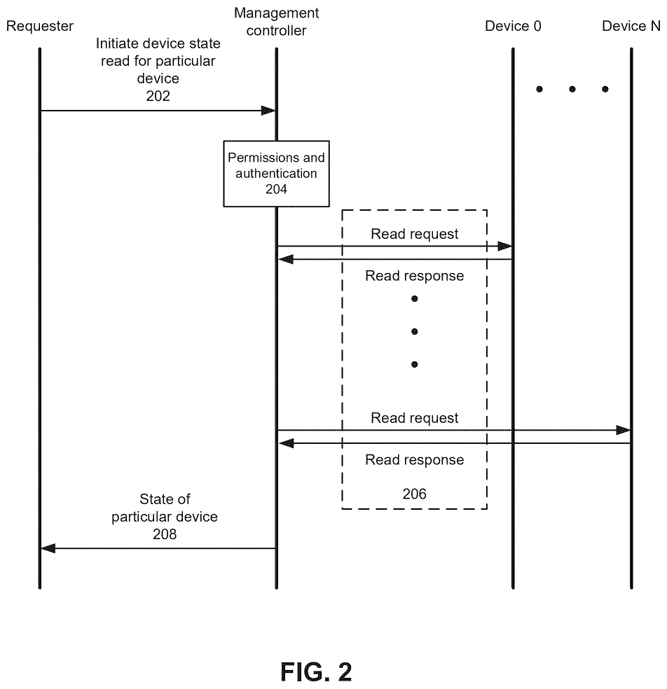

FIG. 2 depicts an example of operations. At 202, a requester can provide a request to a host system that specifies registers to read (e.g., Control and Status Registers (CSR) addresses) or device state of a particular device. The requester can include a device manufacturer, debug engineer, or original equipment manufacturer (OEM). The request can be received using communications consistent with Intelligent Platform Management Interface (IPMI), Redfish, DMTF specifications (e.g., NC-SI, MCTP, PLDM, or others), or others. The device can be a device in validation as device under test. Examples of devices can include an accelerator, graphics processing unit (GPU), storage device, memory device, network interface device, or others.

At 204, a management controller of the host system can validate the request. For example, management controller can be configured to permit requests from a particular internet protocol (IP) address of a requester, permitted registers that can be accessed for particular devices, or others.

At 206, if the request is valid and permitted to be performed, management controller can read the requested data from the particular device(s) via management controller interfaces. Despite devices being inoperative (e.g., device is disconnected from a PCIe bus due to hardware or driver error or PCIe bus may not be accessed by the device), management controller can access the specific registers. At 208, after reading the requested data from the particular device(s) among devices 0 to N, the management controller can pass register information back to the requester. Based on the information, the requester can debug the device or system and provide modified device firmware, driver, or device circuitry. Various examples can accelerate root-cause analysis, reducing downtime, and minimizing the need for on-site support during system integration and field deployment.

While examples are described with respect to reading device state data, various examples can write values to registers or memory of devices, such as programming a media access control (MAC) address of the device, changing a light emitting diode (LED) blinking frequency or color of light, or operations of a host driver.

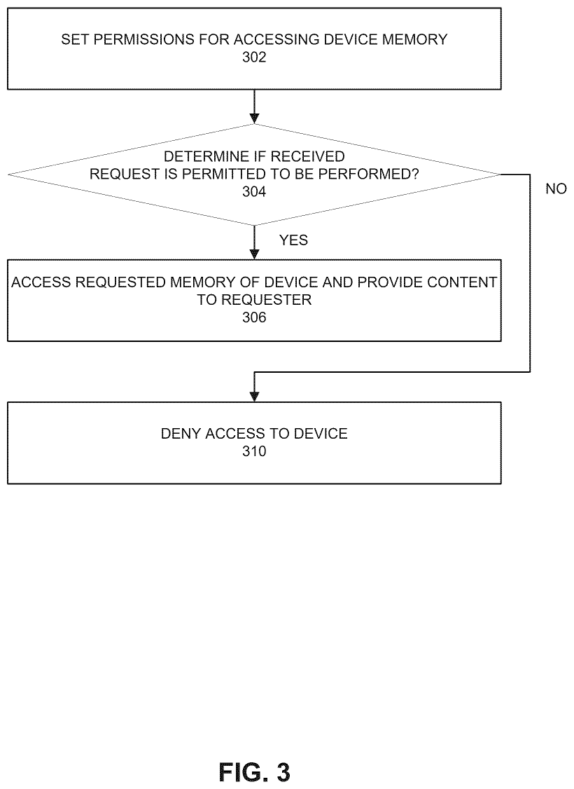

FIG. 3 depicts an example process. At 302, a circuitry can be configured by a setting to determine whether to permit or deny a request to access content stored by a device via an interface that remains operative despite failure to connect with a device interface or the device malfunctioning. The configuration setting can indicate which registers are permitted to be accessed, which devices are permitted to be accessed, whether read or write is permitted by a requester, or other permitted operations for a particular requester. The circuitry can include a management controller or other circuitry that monitors and manages devices coupled to a host system and can connect with the device using an interface other than the device interface utilizing a particular protocol.

At 304, based on receipt of a request to access the registers (e.g., read, write, or read and write), the circuitry can determine whether to permit or deny the request based on the configuration. At 306, based on a determination to permit the request, the circuitry can access the requested content. The content can include device data that indicates state of the device and can be used to determine a reason for the device failing to operate, failing to maintain a connection through the device interface (e.g., PCIe interface), or others. At 306, the circuitry can provide the requested content to the requester via a network interface or other communications.

At 310, the circuitry can deny the request. In some examples, the circuitry can indicate to a data center administrator or orchestrator that an unpermitted request was received. In response to receipt of an unpermitted request, the administrator or orchestrator can send a negative acknowledgement indicating the request will not be performed, send back an invalid command response, or other actions set forth by DMTF protocols.

FIG. 4 depicts an example system. The system can use examples to access state of various circuitries of system 400 (e.g., processor 410, graphics 440, one or more of accelerators 442, management controller (MC) 444, and/or network interface 450), as described herein. System 400 includes processor 410, which provides processing, operation management, and execution of instructions for system 400. Processor 410 can include any type of microprocessor, central processing unit (CPU), graphics processing unit (GPU), processing core, or other processing hardware to provide processing for system 400, or a combination of processors. Processor 410 controls the overall operation of system 400, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 400 includes interface 412 coupled to processor 410, which can represent a higher speed interface or a high throughput interface for system components that needs higher bandwidth connections, such as memory subsystem 420 or graphics interface components 440, accelerators 442, or management controller 444. Interface 412 represents an interface circuit, which can be a standalone component or integrated onto a processor die.

Accelerators 442 can be a fixed function or programmable offload engine that can be accessed or used by a processor 410. For example, an accelerator among accelerators 442 can provide data compression (DC) capability, cryptography services such as public key encryption (PKE), cipher, hash/authentication capabilities, decryption, or other capabilities or services. In some cases, accelerators 442 can be integrated into a CPU socket (e.g., a connector to a motherboard or circuit board that includes a CPU and provides an electrical interface with the CPU). For example, accelerators 442 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 442 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 420 represents the main memory of system 400 and provides storage for code to be executed by processor 410, or data values to be used in executing a routine. Memory subsystem 420 can include one or more memory devices 430 such as read-only memory (ROM), flash memory, one or more varieties of random access memory (RAM) such as static random-access memory (SRAM), dynamic random-access memory (DRAM), or other memory devices, or a combination of such devices. Memory 430 stores and hosts, among other things, operating system (OS) 432 to provide a software platform for execution of instructions in system 400. Additionally, applications 434 can execute on the software platform of OS 432 from memory 430. Applications 434 represent programs that have their own operational logic to perform execution of one or more functions. Processes 436 represent agents or routines that provide auxiliary functions to OS 432 or one or more applications 434 or a combination. OS 432, applications 434, and processes 436 provide software logic to provide functions for system 400. In one example, memory subsystem 420 includes memory controller 422, which is a memory controller to generate and issue commands to memory 430. It will be understood that memory controller 422 could be a physical part of processor 410 or a physical part of interface 412. For example, memory controller 422 can be an integrated memory controller, integrated onto a circuit with processor 410.

In some examples, OS 432 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 400 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 400 includes interface 414, which can be coupled to interface 412. In one example, interface 414 represents an interface circuit, which can include standalone components and integrated circuitry. In one example, multiple user interface components or peripheral components, or both, couple to interface 414. Network interface 450 provides system 400 the ability to communicate with remote devices (e.g., servers or other computing devices) over one or more networks. In some examples, network interface 450 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 450 can include an Ethernet adapter, wireless interconnection components, cellular network interconnection components, USB (universal serial bus), or other wired or wireless standards-based or proprietary interfaces. Network interface 450 can transmit data to a device that is in the same data center or rack or a remote device, which can include sending data stored in memory.

Some examples of network interface 450 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 450 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONIC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 400 includes one or more input/output (I/O) interface(s) 460. I/O interface 460 can include one or more interface components through which a user interacts with system 400 (e.g., audio, alphanumeric, tactile/touch, or other interfacing). Peripheral interface 470 can include any hardware interface not specifically mentioned above. Peripherals refer generally to devices that connect dependently to system 400. A dependent connection is one where system 400 provides the software platform or hardware platform or both on which operation executes, and with which a user interacts.

In one example, system 400 includes storage subsystem 480 to store data in a nonvolatile manner. In one example, in certain system implementations, at least certain components of storage 480 can overlap with components of memory subsystem 420. Storage subsystem 480 includes storage device(s) 484, which can be or include any conventional medium for storing large amounts of data in a nonvolatile manner, such as one or more magnetic, solid state, or optical based disks, or a combination. Storage 484 holds code or instructions and data 486 in a persistent state (e.g., the value is retained despite interruption of power to system 400). Storage 484 can be generically considered to be a “memory,” although memory 430 is typically the executing or operating memory to provide instructions to processor 410. Whereas storage 484 is nonvolatile, memory 430 can include volatile memory (e.g., the value or state of the data is indeterminate if power is interrupted to system 400). In one example, storage subsystem 480 includes controller 482 to interface with storage 484. In one example controller 482 is a physical part of interface 414 or processor 410 or can include circuits or logic in both processor 410 and interface 414.

A volatile memory is memory whose state (and therefore the data stored in it) is indeterminate if power is interrupted to the device. A non-volatile memory (NVM) device is a memory whose state is determinate even if power is interrupted to the device.

In an example, system 400 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., Peripheral Component Interconnect express (PCIe), Compute Express Link (CXL), UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more later examples and includes an apparatus comprising: a first interface to a device; a second interface to the device; and a circuitry to: based on inoperability of the first interface or inoperability of the device, utilize the second interface to communicate with the device and to retrieve debug data from the device and provide the debug data to a requester, wherein the first and second interfaces utilize different protocols.

Example 2 includes one or more later or earlier examples, wherein the debug data comprises three or more of: timestamped events, error messages, informational messages generated by the device's firmware or software, connectivity errors, hardware errors, or system events.

Example 3 includes one or more later or earlier examples, wherein: the circuitry comprises a management controller to manage and monitor operation the device.

Example 4 includes one or more later or earlier examples, wherein: the circuitry is to permit or deny accesses to the device through the second interface based on a configuration.

Example 5 includes one or more later or earlier examples, wherein: the first interface comprises a device interface, the second interface comprises a management controller interface to the device, and the management controller interface is to remain operative despite inoperability of the device and inoperability of the first interface.

Example 6 includes one or more later or earlier examples, wherein: the first interface is to operate in a manner consistent with a Peripheral Component Interface express (PCIe) protocol and the second interface is to communicate with the device based on a Distributed Management Task Force (DMTF) protocol.

Example 7 includes one or more later or earlier examples, wherein the device comprises one or more of: an accelerator, graphics processing unit (GPU), storage device, memory device, or network interface device.

Example 8 includes one or more later or earlier examples, and includes at least one non-transitory computer-readable medium comprising instructions stored thereon, that when executed by one or more processors, cause the one or more processors to: configure circuitry to: based on inoperability of a first interface to a device or inoperability of the device, utilize a second interface to communicate with the device and to retrieve data from the device and provide the data to a requester, wherein the first and second interfaces utilize different protocols.

Example 9 includes one or more later or earlier examples, wherein the data comprises three or more of: timestamped events, error messages, informational messages generated by the device's firmware or software, connectivity errors, hardware errors, or system events.

Example 10 includes one or more later or earlier examples, wherein the circuitry comprises a management controller to manage and monitor operation the device.

Example 11 includes one or more later or earlier examples, wherein the circuitry is to permit or deny accesses to the device through the second interface based on a configuration.

Example 12 includes one or more later or earlier examples, wherein the first interface comprises a device interface, the second interface comprises a management controller interface to the device, and the management controller interface is to remain operative despite inoperability of the device.

Example 13 includes one or more later or earlier examples, wherein: the first interface is to operate in a manner consistent with a Peripheral Component Interface express (PCIe) protocol and the second interface is to communicate with the device based on a Distributed Management Task Force (DMTF) protocol comprising one or more of: Network Controller Sideband Interface (NC-SI), Management Component Transport Protocol (MCTP), Platform Level Data Model (PLDM).

Example 14 includes one or more later or earlier examples, and includes a method that includes: based on inoperability of a first interface to a device or inoperability of the device, utilizing a second interface to communicate with the device for retrieving data from the device and providing the data to a requester, wherein the first and second interfaces utilize different protocols.

Example 15 includes one or more later or earlier examples, wherein the data comprises three or more of: timestamped events, error messages, informational messages generated by the device's firmware or software, connectivity errors, hardware errors, or system events.

Example 16 includes one or more later or earlier examples, and includes a management controller performing the utilizing the second interface to communicate with the device for retrieving data from the device.

Example 17 includes one or more later or earlier examples, and includes a management controller permitting or denying a request to access the device via the second interface.

Example 18 includes one or more later or earlier examples, wherein: the first interface comprises a device interface, the second interface comprises a management controller interface to the device, and the management controller interface is to remain operative despite inoperability of the device.

Example 19 includes one or more later or earlier examples, wherein the first interface is to operate in a manner consistent with a Peripheral Component Interface express (PCIe) protocol.

Example 20 includes one or more earlier examples, wherein the second interface is to communicate with the device based on a Distributed Management Task Force (DMTF) protocol.

1. An apparatus comprising:
a first interface to a device;
a second interface to the device; and
a circuitry to:
based on inoperability of the first interface or inoperability of the device, utilize the second interface to communicate with the device and to retrieve debug data from the device and provide the debug data to a requester, wherein the first and second interfaces utilize different protocols.

2. The apparatus of claim 1, wherein the debug data comprises three or more of: timestamped events, error messages, informational messages generated by the device's firmware or software, connectivity errors, hardware errors, or system events.

3. The apparatus of claim 1, wherein:
the circuitry comprises a management controller to manage and monitor operation the device.

4. The apparatus of claim 1, wherein:
the circuitry is to permit or deny accesses to the device through the second interface based on a configuration.

5. The apparatus of claim 1, wherein:
the first interface comprises a device interface,
the second interface comprises a management controller interface to the device, and
the management controller interface is to remain operative despite inoperability of the device and inoperability of the first interface.

6. The apparatus of claim 1, wherein:
the first interface is to operate in a manner consistent with a Peripheral Component Interface express (PCIe) protocol and
the second interface is to communicate with the device based on a Distributed Management Task Force (DMTF) protocol.

7. The apparatus of claim 1, wherein the device comprises one or more of: an accelerator, graphics processing unit (GPU), storage device, memory device, or network interface device.

8. At least one non-transitory computer-readable medium comprising instructions stored thereon, that when executed by one or more processors, cause the one or more processors to:
configure circuitry to:
based on inoperability of a first interface to a device or inoperability of the device, utilize a second interface to communicate with the device and to retrieve data from the device and provide the data to a requester, wherein the first and second interfaces utilize different protocols.

9. The computer-readable medium of claim 8, wherein the data comprises three or more of: timestamped events, error messages, informational messages generated by the device's firmware or software, connectivity errors, hardware errors, or system events.

10. The computer-readable medium of claim 8, wherein the circuitry comprises a management controller to manage and monitor operation the device.

11. The computer-readable medium of claim 8, wherein the circuitry is to permit or deny accesses to the device through the second interface based on a configuration.

12. The computer-readable medium of claim 8, wherein
the first interface comprises a device interface,
the second interface comprises a management controller interface to the device, and
the management controller interface is to remain operative despite inoperability of the device.

13. The computer-readable medium of claim 8, wherein:
the first interface is to operate in a manner consistent with a Peripheral Component Interface express (PCIe) protocol and
the second interface is to communicate with the device based on a Distributed Management Task Force (DMTF) protocol comprising one or more of: Network Controller Sideband Interface (NC-SI), Management Component Transport Protocol (MCTP), Platform Level Data Model (PLDM).

14. A method comprising:
based on inoperability of a first interface to a device or inoperability of the device, utilizing a second interface to communicate with the device for retrieving data from the device and
providing the data to a requester, wherein the first and second interfaces utilize different protocols.

15. The method of claim 14, wherein the data comprises three or more of: timestamped events, error messages, informational messages generated by the device's firmware or software, connectivity errors, hardware errors, or system events.

16. The method of claim 14, comprising a management controller performing the utilizing the second interface to communicate with the device for retrieving data from the device.

17. The method of claim 14, comprising a management controller permitting or denying a request to access the device via the second interface.

18. The method of claim 14, wherein:
the first interface comprises a device interface,
the second interface comprises a management controller interface to the device, and
the management controller interface is to remain operative despite inoperability of the device.

19. The method of claim 14, wherein the first interface is to operate in a manner consistent with a Peripheral Component Interface express (PCIe) protocol.

20. The method of claim 14, wherein the second interface is to communicate with the device based on a Distributed Management Task Force (DMTF) protocol.
